(19) United States
(12) Patent Application Publication
(10) Pub. No.: US 2020/0147675 A1
(43) Pub. Date: May 14, 2020

(54) ALUMINUM ALLOYS FOR USE IN ELECTROCHEMICAL CELLS AND METHODS OF MAKING AND USING THE SAME

(71) Applicant: Arconic Inc., Pittsburgh, PA (US)

(72) Inventors: Hasso Weiland, Lower Burrell, PA (US); Ali Unal, Export, PA (US)

(21) Appl. No.: 16/743,309

(22) Filed: Jan. 15, 2020

Related U.S. Application Data
(63) Continuation of application No. PCT/US2018/048848, filed on Aug. 30, 2018.
(60) Provisional application No. 62/552,600, filed on Aug. 31, 2017.

(51) Int. Cl. B22D 11/00; H01M 4/46

(52) U.S. Cl. CPC B22D 11/003; B33Y 10/00; H01M 4/463

(57) ABSTRACT

New aluminum electrode alloys and methods of making the same are disclosed. In one embodiment, a method comprises, casting an aluminum alloy into an as-cast product, wherein the aluminum alloy comprises from 0.005 wt. % to 0.06 wt. % Fe, and forming the as-cast product into an aluminum electrode alloy. The casting step may comprise solidifying at a solidification rate. The solidification rate may be at or above a threshold solidification rate. The threshold solidification rate is sufficient to achieve not greater than 0.04 vol. % of Fe particles.

### CROSS-REFERENCE TO RELATED APPLICATION

This application is a continuation of International Patent App. No. PCT/US2018/048848, filed Aug. 30, 2018, which claims the benefit of priority to U.S. Patent Application No. 62/552,600, filed Aug. 31, 2017, each of which is incorporated herein by reference in its entirety.

### FIELD OF THE INVENTION

The present disclosure is directed towards aluminum alloys for use in electrochemical cells and methods of making and using the same.

### BACKGROUND

Clean, sustainable energy is a global concern. Electrochemical cells are utilized as clean, sustainable energy. By commercially deploying these sustainable forms of energy, it is possible to lower the global dependence on fossil fuels.

### SUMMARY OF THE INVENTION

Utilizing aluminum alloy compositions as an electrode (anode) in an electrochemical cell can be evaluated by quantifying and/or qualifying two phenomena: (1) the anodic reaction and (2) the corrosion reaction of the aluminum alloy composition. In the anodic reaction, aluminum reacts with hydroxyl ions which results in the release of electrons, the primary and desirable product of an electrochemical cell. Without being bound by any particular mechanism or theory, it is believed that in the corrosion reaction, the aluminum in the anode material is oxidized in the presence of water and as the oxygen in the water reacts with the aluminum, aluminum oxide is formed, generating hydrogen gas as a byproduct of the corrosion reaction of the aluminum alloy composition. In the corrosion reaction, aluminum is consumed without contributing to the production of (creating) electrical energy in the electrochemical cell.

Without being bound by a particular mechanism or theory, it is believed that by reducing the amount of the corrosion reaction, more electrode material is available to participate in the anodic reaction, contributing to the longevity of the anode and production of electrical energy by the electrochemical cell.

The extent of the corrosion reaction, i.e. the amount of hydrogen generated for an aluminum alloy used as an anode, is a function of electrolyte temperatures and current densities in the electrochemical cell. As operating temperatures and applied current vary for the operation of the cell, so too does the aluminum alloy composition experience varying instances of high anodic reaction and high corrosion reaction windows within the operating parameters/ranges of the electrolytic cell.

i. Composition

The new aluminum alloys used to produce the new aluminum electrode alloys described herein may be any suitable aluminum alloy having low amounts of iron (e.g. from 0.005 wt. % Fe to 0.06 wt. % Fe). For the purposes of this patent application, a reference to an aluminum alloy composition is also a reference to an aluminum electrode alloy composition.

As used herein, “aluminum alloy” means an alloy having aluminum as the predominant alloying element. As used herein, the phrase “aluminum electrode alloy” means an aluminum electrode alloy configured for use as an anode or cathode in an electrochemical cell. In one embodiment, an aluminum alloy is one of a 1xxx, 2xxx, 3xxx, 4xxx, 5xxx, 6xxx, 7xxx, or 8xxx series aluminum alloys, as defined by the Aluminum Association document “International Alloy Designations and Chemical Composition Limits for Wrought Aluminum and Wrought Aluminum Alloys” (2015). In another embodiment, the aluminum alloy is a 1xxx series aluminum alloy. In yet another embodiment, the aluminum alloy is a 2xxx series aluminum alloy. In another embodiment, the aluminum alloy is a 3xxx series aluminum alloy. In yet another embodiment, the aluminum alloy is a 4xxx series aluminum alloy. In another embodiment, the aluminum alloy is a 5xxx series aluminum alloy. In yet another embodiment, the aluminum alloy is 6xxx series aluminum alloy. In another embodiment, the aluminum alloy is a 7xxx series aluminum alloy. In yet another embodiment, the aluminum alloy is an 8xxx series aluminum alloy. In another embodiment, the aluminum alloy is selected from the group consisting of a 1xxx series aluminum alloy and a 5xxx series aluminum alloy. In one embodiment, the aluminum electrode alloy may comprise a 5252 aluminum alloy. In another embodiment, the aluminum electrode alloy may comprise a 5005 aluminum alloy.

As noted above, the aluminum alloys may include from 0.005 to 0.06 wt. % Fe. Low iron content may facilitate, for instance, lower corrosion, i.e. hydrogen generation. In one embodiment, the aluminum alloy includes at least 0.006 wt. % Fe. In another embodiment, the aluminum alloy includes at least 0.01 wt. % Fe. In yet another embodiment, the aluminum alloy includes at least 0.02 wt. % Fe. In another embodiment, the aluminum alloy includes at least 0.03 wt. % Fe. In yet another embodiment, the aluminum alloy includes at least 0.04 wt. % Fe. In another embodiment, the aluminum alloy includes at least 0.005 wt. % Fe. In one embodiment, the aluminum alloy includes not greater than 0.06 wt. % Fe. In another embodiment, the aluminum alloy includes not greater than 0.05 wt. % Fe. In yet another embodiment, the aluminum alloy includes not greater than 0.04 wt. % Fe. In another embodiment, the aluminum alloy includes not greater than 0.03 wt. % Fe. In yet another embodiment, the aluminum alloy includes not greater than 0.025 wt. % Fe. In one embodiment, the aluminum alloy includes 0.01 to 0.06 wt. % Fe. In another embodiment, the aluminum alloy includes 0.02 to 0.06 wt. % Fe. In yet another embodiment, the aluminum alloy includes 0.03 to 0.06 wt. % Fe. In another embodiment, the aluminum alloy includes 0.04 to 0.06 wt. % Fe. In yet another embodiment, the aluminum alloy includes 0.02 to 0.05 wt. % Fe. In another embodiment, the aluminum alloy includes 0.02 to 0.04 wt. % Fe. In yet another embodiment, the aluminum alloy includes 0.02 to 0.03 wt. % Fe. In another embodiment, the aluminum alloy includes 0.02 to 0.025 wt. % Fe. Appropriate aluminum alloy base materials may be used to facilitate casting of the new aluminum alloy; such base materials generally will have similar iron and silicon contents. Thus, the aluminum alloys described herein generally contain silicon levels similar to the above-described levels of iron.

As noted above, the new aluminum alloys may be a 5xxx series alloy. In one embodiment, the aluminum alloy may include at least 0.01 wt. % Mg. In another embodiment, the aluminum alloy may include at least 0.1 wt. % Mg. In yet another embodiment, the aluminum alloy may include at least 0.5 wt. % Mg. In another embodiment, the aluminum alloy may include at least 1.0 wt. % Mg. In yet another embodiment, the aluminum alloy may include at least 1.5 wt. % Mg. In another embodiment, the aluminum alloy may include at least 2.0 wt. % Mg. In one embodiment, the aluminum alloy may include up to 5.0 wt. % Mg. In one embodiment, the aluminum alloy may include not greater than 4.0 wt. % Mg. In another embodiment, the aluminum alloy may include not greater than 3.0 wt. % Mg. In yet another embodiment, the aluminum alloy may include not greater than 2.0 wt. % Mg. In another embodiment, the aluminum alloy may include not greater than 1.5 wt. % Mg. In yet another embodiment, the aluminum alloy may include not greater than 1.0 wt. % Mg. In another embodiment, the aluminum alloy may include not greater than 0.5 wt. % Mg. In one embodiment, the aluminum alloy may include 0.01 to 5.0 wt. % Mg. In another embodiment, the aluminum alloy may include 0.1 to 5.0 wt. % Mg. In yet another embodiment, the aluminum alloy may include 0.5 to 5.0 wt. % Mg. In another embodiment, the aluminum alloy may include 1.0 to 5.0 wt. % Mg. In yet another embodiment, the aluminum alloy may include 1.5 to 5.0 wt. % Mg. In another embodiment, the aluminum alloy may include 2.0 to 5.0 wt. % Mg. In yet another embodiment, the aluminum alloy may include 3.0 to 5.0 wt. % Mg. In another embodiment, the aluminum alloy may include 4.0 to 5.0 wt. % Mg. In another embodiment, the aluminum alloy may include 0.01 to 4.0 wt. % Mg. In yet another embodiment, the aluminum alloy may include 0.01 to 3.0 wt. % Mg. In another embodiment, the aluminum alloy may include 0.01 to 2.0 wt. % Mg. In another embodiment, the aluminum alloy may include 0.01 to 1.5 wt. % Mg. In another embodiment, the aluminum alloy may include 0.01 to 1.0 wt. % Mg. In one embodiment, the aluminum alloy has no Mg (i.e. includes Mg as an impurity only).

In some embodiments, the new aluminum alloy may be substantially free of impurities, meaning that the alloy contains no more than 0.10 wt. % of any one impurity, and that the total combined amount of the impurities in the aluminum alloy does not exceed 0.35 wt. %. In one embodiment, each one of the impurities, individually, does not exceed 0.05 wt. % in the aluminum alloy, and the total combined amount of the impurities does not exceed about 0.15 wt. %. In another embodiment, each one of the impurities, individually, does not exceed 0.03 wt. % in the aluminum alloy, and the total combined amount of the impurities does not exceed about 0.12 wt. %. In yet another embodiment, each one of the impurities, individually, does not exceed 0.01 wt. % in the aluminum alloy, and the total combined amount of the impurities does not exceed about 0.03 wt. %.

ii. Processing

The new aluminum alloys described herein may be formed/processed by any suitable processing method. In one embodiment, and with reference now to FIG. 4, a method comprises casting the aluminum alloy (100) and then forming an aluminum electrode alloy (200) from the cast aluminum alloy. The composition of the aluminum alloy may be any composition described in Section i, above.

Regarding the casting step (100), the casting may be any suitable casting method. In one embodiment, the casting (100) may be continuous casting. In one embodiment, the continuous casting comprises continuous casting as described in U.S. Pat. Nos. 7,823,623, 7,380,583, and 6,672,368. In another embodiment, the continuous casting comprises roll casting. In yet another embodiment, the continuous casting comprises belt casting. In another embodiment, the continuous casting comprises block casting. In one embodiment, the continuous casting may result in an as-cast product in the form of a strip. In one embodiment, the casting may be shape casting. In one embodiment, the shape casting comprises die casting. In one embodiment, the casting (100) may be semi-continuous casting. In one embodiment, the semi-continuous casting may be direct chill casting. In one embodiment, the direct chill casting may result in an as-cast product in the form of an ingot or billet. In one embodiment, the casting comprises additive manufacturing processes.

In one embodiment, the casting step (100) comprises solidifying a melt (150) of the aluminum alloy. The solidification rate of the solidifying step (150) may be any appropriate rate that facilitates achievement of a suitable amount of iron particles in the aluminum alloy. As used herein, “solidification rate” means the rate of cooling of a molten material (e.g. molten alloy, molten aluminum alloy), which is defined as the rate of temperature loss (in Kelvin/second) in the liquid metal immediately ahead of the solidification front. For example, solidification of a molten aluminum alloy during cooling occurs over a temperature range, which depends upon the alloying elements in that particular alloy material. As a non-limiting example, the solidification rate is sometimes deduced and/or quantified from the spacing of the secondary dendrite arms in the as-cast product. In one embodiment, the solidification rate is selected based, at least in part, on the amount of iron in solid solution, e.g. as shown in FIG. 1.

The amount of iron in the aluminum alloy may be related to the amount of hydrogen generated when a current is applied to an aluminum electrode alloy in an electrochemical cell. The total amount of iron in the as-cast alloy is the sum of iron in solid solution and the iron contained in iron-bearing particles (“iron particles”). Iron in solid solution may contribute less to the hydrogen generation than iron particles. Thus, the presence of iron particles may be detrimental vis-à-vis hydrogen generation. In one embodiment, and referring back to FIG. 4, as a result of the solidification rate of the casting process (100), the cast aluminum alloy may contain iron in solid solution and/or iron particles. In one embodiment, the total amount of iron in the as-cast alloys may be determined by chemical analysis such as a Quantometer (spark source optical emission spectrometry). In one embodiment, the volume fraction of iron particles (vol. % of iron) in the as-cast alloys may be quantified by SEM analysis. The quantification process is described in detail in Example 3.

In one embodiment, an as-cast aluminum alloy includes not greater than 0.04 vol. % of iron particles. In another embodiment, an as-cast aluminum alloy includes not greater than 0.03 vol. % of iron particles. In yet another embodiment, an as-cast aluminum alloy includes not greater than 0.02 vol. % of iron particles. In another embodiment, an as-cast aluminum alloy includes not greater than 0.01 vol. % of iron particles. In one embodiment, the iron particles are iron-bearing intermetallic particles. In yet another embodiment, an as-cast aluminum alloy includes not greater than 0.005 vol. % of iron particles.

In one embodiment, the solidification rate is at or above a threshold solidification rate, and the threshold solidification rate is sufficiently high to achieve a volume fraction of iron particles in the as-cast product of not greater than 0.04 vol. %. In another embodiment the solidification rate is at or above a threshold solidification rate, and the threshold solidification rate is sufficiently high to achieve a volume fraction of iron particles in the as-cast product of not greater than 0.03 vol. %. In yet another embodiment the solidification rate is at or above a threshold solidification rate, and the threshold solidification rate is sufficiently high to achieve a volume fraction of iron particles in the as-cast product of not greater than 0.02 vol. %. In another embodiment the solidification rate is at or above a threshold solidification rate, and the threshold solidification rate is sufficiently high to achieve a volume fraction of iron particles in the as-cast product of not greater than 0.01 vol. %. In yet another embodiment the solidification rate is at or above a threshold solidification rate, and the threshold solidification rate is sufficiently high to achieve a volume fraction of iron particles in the as-cast product of not greater than 0.005 vol. %.

In one embodiment, the casting process is conducted to achieve a solidification rate of at least 10 Kelvin/second (K/s). In another embodiment, the casting process is conducted to achieve a solidification rate of at least 50 K/s. In yet another embodiment, the casting process is conducted to achieve a solidification rate of at least 70 K/s. In another embodiment, the casting process is conducted to achieve a solidification rate of at least 100 Kelvin K/s. In yet another embodiment, the casting process is conducted to achieve a solidification rate of at least 150 Kelvin K/s. In one embodiment, the casting process is conducted to achieve a solidification rate of 10K/s to 200 K/s. In yet another embodiment, the casting process is conducted to achieve a solidification rate of 70 K/s to 200 K/s. In another embodiment, the casting process is conducted to achieve a solidification rate of 100 K/s to 200 K/s. In yet another embodiment, the casting process is conducted to achieve a solidification rate of 150 K/second to 200 K/second. In another embodiment, the casting process is conducted to achieve a solidification rate of 10 K/s to 150 K/s. In yet another embodiment, the casting process is conducted to achieve a solidification rate of 50 K/s to 150 K/s. In another embodiment, the casting process is conducted to achieve a solidification rate of 50 K/s to 100 K/s. In yet another embodiment, the casting process is conducted to achieve a solidification rate of 50 K/s to 75 K/s. In one embodiment, the casting process is conducted to achieve a solidification rate of 10 K/s to 3000 K/s. In one embodiment, the casting process is conducted to achieve a solidification rate is 50 K/sec-3000 K/sec. In one embodiment, the casting process is conducted to achieve a solidification rate of 50 K/s to 500 K/s.

With continued reference to FIG. 4, in embodiments where continuous casting is used, after the casting (100), the as-cast product may have any suitable as-cast thickness (e.g. to achieve appropriate solidification rates (150)). Faster solidification rates may be achieved in thinner as-cast alloys. In one embodiment, the as-cast aluminum alloy comprises a thickness of at least 1 millimeter (mm). In another embodiment, the as-cast aluminum alloy comprises a thickness of at least 2 mm. In yet another embodiment, the as-cast aluminum alloy comprises a thickness of at least 3 mm. In another embodiment, the as-cast aluminum alloy comprises a thickness of at least 5 mm. In yet another embodiment, the as-cast aluminum alloy comprises a thickness of at least 10 mm. In another embodiment, the as-cast aluminum alloy comprises a thickness of at least 12 mm. In yet another embodiment, the as-cast aluminum alloy comprises a thickness of at least 15 mm. In another embodiment, the as-cast aluminum alloy comprises a thickness of at least 20 mm. In one embodiment, the as-cast aluminum alloy comprises a thickness of not greater than 25 mm. In another embodiment, the as-cast aluminum alloy comprises a thickness of not greater than 20 mm. In yet another embodiment, the as-cast aluminum alloy comprises a thickness of not greater than 15 mm. In another embodiment, the as-cast aluminum alloy comprises a thickness of not greater than 12 mm. In yet another embodiment, the as-cast aluminum alloy comprises a thickness of not greater than 10 mm. In another embodiment, the as-cast aluminum alloy comprises a thickness of not greater than 8 mm. In yet another embodiment, the as-cast aluminum alloy comprises a thickness of not greater than 5 mm. In another embodiment, the as-cast aluminum alloy comprises a thickness of not greater than 3 mm. In yet another embodiment, the as-cast aluminum alloy comprises a thickness of not greater than 2 mm. In one embodiment, the as-cast aluminum alloy comprises a thickness of 1 to 25 mm. In another embodiment, the as-cast aluminum alloy comprises a thickness of 1 to 20 mm. In yet another embodiment, the as-cast aluminum alloy comprises a thickness of 1 to 15 mm. In another embodiment, the as-cast aluminum alloy comprises a thickness of 1 to 12 mm. In yet another embodiment, the as-cast aluminum alloy comprises a thickness of 1 to 10 mm. In another embodiment, the as-cast aluminum alloy comprises a thickness of 1 to 8 mm. In yet another embodiment, the as-cast aluminum alloy comprises a thickness of 1 to 5 mm. In another embodiment, the as-cast aluminum alloy comprises a thickness of 1 to 3 mm. In yet another embodiment, the as-cast aluminum alloy comprises a thickness of 1 to 2 mm. In another embodiment, the as-cast aluminum alloy comprises a thickness of 2 to 25 mm. In yet another embodiment, the as-cast aluminum alloy comprises a thickness of 3 to 25 mm. In another embodiment, the as-cast aluminum alloy comprises a thickness of 5 to 25 mm. In yet another embodiment, the as-cast aluminum alloy comprises a thickness of 10 to 25 mm. In another embodiment, the as-cast aluminum alloy comprises a thickness of 12 to 25 mm. In yet another embodiment, the as-cast aluminum alloy comprises a thickness of 15 to 25 mm. In another embodiment, the as-cast aluminum electrode alloy comprises a thickness of 20 to 25 mm.

With continued reference to FIG. 4, after casting (100), the cast aluminum alloy may be formed into an aluminum electrode alloy (200). In one embodiment, the forming may comprise working of the as-cast alloy. In one embodiment, due to the working, the formed aluminum electrode alloy may comprise a wrought microstructure. In one embodiment, the working may include rolling. In one embodiment, the rolling may include hot and/or cold rolling. In one embodiment, the rolled product is a sheet. In another embodiment, the rolled product is a foil. In yet another embodiment, the rolled product is a plate. In one embodiment, the working may include extruding. In another embodiment, the working may include forging. In one embodiment, the working may comprise free form forging, also known as open die forging. In one embodiment, the forming may include solution heat treatment.

Referring now to FIG. 5, after the forming step (200), the method may comprise producing the final product form (300). In one embodiment, the producing (300) may comprise machining. In another embodiment, the producing (300) may comprise cutting. In yet another embodiment, the producing (300) may comprise stamping. In another embodiment the producing (300) comprises producing disc. In yet another embodiment, the producing (300) comprises producing a block.

With continued reference to FIG. 5 an aluminum alloy may be selected (50) from one of the previously described aluminum alloy compositions. An appropriate aluminum alloy may be selected, e.g. to achieve a low volume fraction of iron particles. In one embodiment, a user may predetermine an aluminum alloy composition prior to the selecting step (50).

iii. Properties

In one embodiment, the new aluminum electrode alloy has improved corrosion resistance when compared to an aluminum electrode alloy with a similar composition processed at solidification rates less than the threshold solidification rate. The improved corrosion resistance comprises: a reduced hydrogen generation rate in an electrochemical cell test, when compared to an aluminum electrode alloy of the same composition, which does not meet the threshold solidification rate.

The figures constitute a part of this specification and include illustrative embodiments of the present invention and illustrate various objects and features thereof. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

### BRIEF DESCRIPTION OF THE DRAWINGS

FIG. 1 provides a graphical representation of the relationship between iron in solid solution (in weight percent) vs. cooling rate (or, solidification rate) measured in K/sec, for four different aluminum alloys having different contents of Iron (e.g. 0.04 wt. % Fe, 0.1 wt. % Fe; 0.25 wt. % Fe; and 0.55 wt. % Fe.), available at: Miki, I et al (1975), J. Japan Inst Light Metals, Vol 25, 1-9.

FIG. 2 provides a schematic view of an example of an electrochemical cell that is configured for use in conjunction with Example 1 and Example 2, to evaluate the corrosion of electrodes in an electrolyte, in accordance with quantifying corrosion resistance with one or more of the present embodiments.

FIG. 3 provides experimental data on total hydrogen generated per kilogram aluminum and total volume fraction of Fe bearing particles when three different compositions (low iron, medium iron, and high iron), each produced at two different solidification rates, were analytically evaluated, in accordance with one or more embodiments of the present disclosure.

FIG. 4 is a flow chart illustrating one embodiment of the processing steps for producing an aluminum electrode alloy.

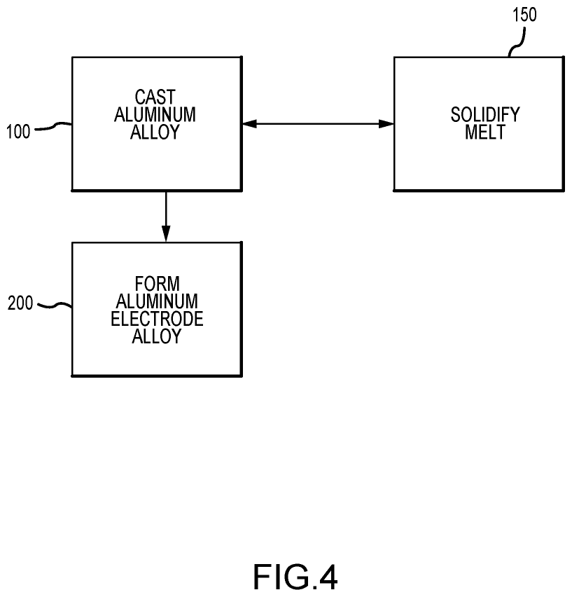

FIG. 5 is a flow chart illustrating another embodiment of the processing steps for producing an aluminum electrode alloy.

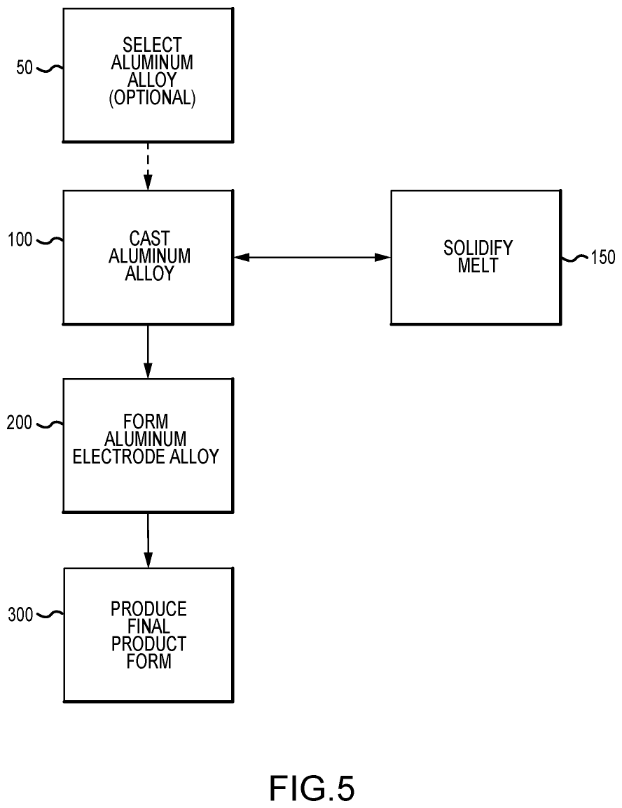

### DETAILED DESCRIPTION

The various embodiments to the present disclosure will be further explained with reference to the attached drawings, wherein like structures are referred to by like numerals throughout the several views. The drawings shown are not necessarily to scale, with emphasis instead generally being placed upon illustrating the principles of the present invention. Further, some features may be exaggerated to show details of particular components.

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention is intended to be illustrative, and not restrictive.

Throughout the specification and claims, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on”.

The following examples are intended to illustrate the invention and should not be construed as limiting the invention in any way.

### EXAMPLES

### Example 1

The alloys of the comparative examples consist essentially of the Fe, and Mg weight percentages shown in Table 1, the balance being aluminum, incidental elements and impurities.

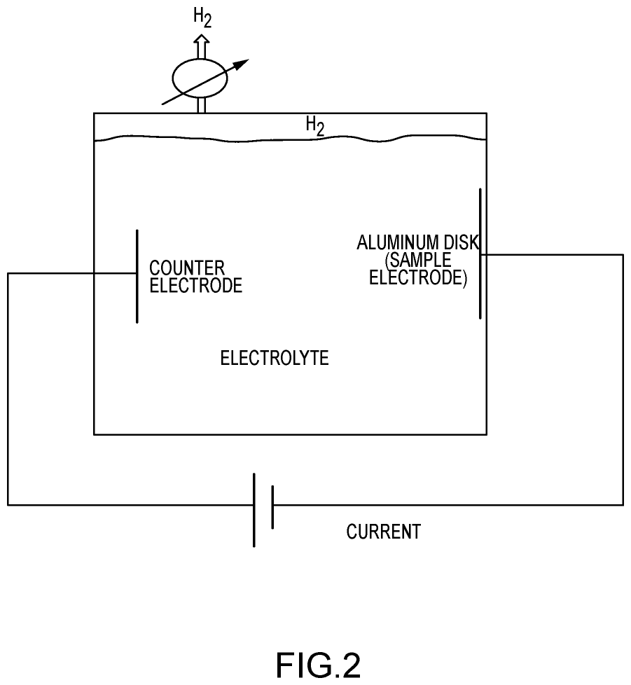

Aluminum alloys, having the compositions shown in Table 1, below, were cast as ingots (i.e. for “slow” solidification) or continuously cast using a belt caster (i.e. for “fast” solidification), rolled to the desired thickness, and machined into disks (samples) having the desired thickness and a diameter, with a sufficient cross-sectional surface area to provide a viable testing surface for immersion into an electrochemical cell, schematically depicted in FIG. 2, for the evaluation of corrosion within the range of operating conditions of the cell (e.g. time, temperatures, current, etc.).

TABLE 1

| Sample | Mg (wt. %) | Fe (wt. %) | |
|---|---|---|---|
| Comparative Alloy - Low Iron | 2.5 | <0.006 wt. % | (<60 ppm) |
| Medium Iron | 2.5 | 0.010 wt. % | (100 ppm) |
| High Iron | 2.5 | 0.019 wt. % | (190 ppm) |

During casting, two different solidification rates were employed: a “slow” solidification rate and a “fast” solidification rate. The slow solidification rate was cast at a solidification rate of 0.4 K/s by pouring the molten aluminum alloy into a copper mold, while the fast solidification rate was cast using a belt caster at a solidification rate of at least 50 K/s to not greater than 200 K/s. In this embodiment, the threshold solidification rate was 50K/s.

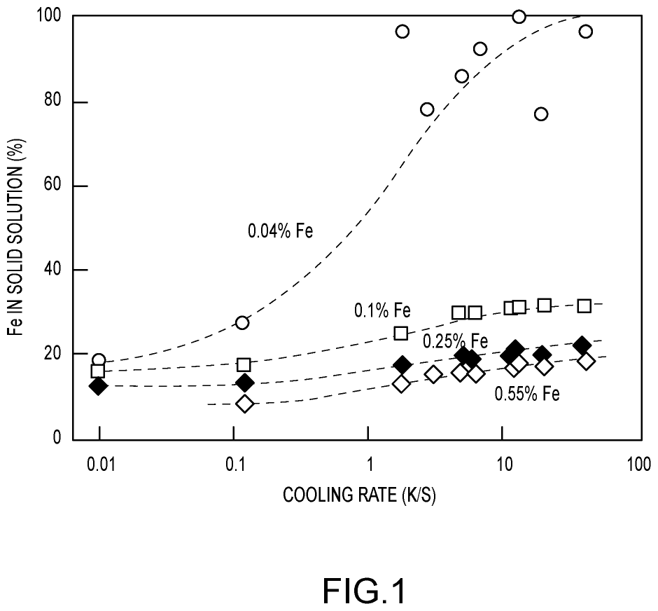

As depicted in FIG. 1, preparing the aluminum alloy at a solidification rate (e.g. cooling rate K/s) above about 10 K/s allows more than 90% of the total iron to be retained in solid solution e.g. 92-99% of the total iron is in solid solution with a solidification rate above 10 K/sec.), for an aluminum alloy containing totally 0.04 wt. % Fe. Thus, in some embodiments, the threshold solidification rate may be at least 10K/s.

Next, disks of three different alloys at two different solidification rates were evaluated according an electrochemical cell test for hydrogen generation, the results of which are described in Example 2.

### Example 2—Testing Aluminum Electrode Alloys

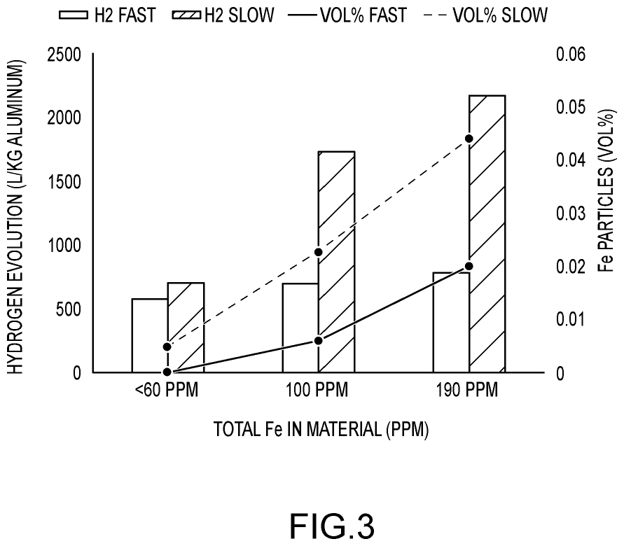

The samples of Example 1 were evaluated for total hydrogen generation in liters per kilogram (e.g. corrosion) in an electrochemical cell. A schematic representation of the utilized electrochemical cell is depicted in FIG. 2. The results are illustrated in FIG. 3.

The electrochemical cell system is designed to simulate anode conditions in an electrochemical device. The electrochemical cell consists of a counter electrode and an aluminum electrode submerged in an aqueous electrolyte. The electrochemical cell is equipped with a mass-flow meter for measuring hydrogen gas evolved from the aluminum electrode as current is applied to the aluminum electrode.

The samples were tested according to the following procedure. A predefined temperature-and-current step control program was applied to the cell so that the hydrogen evolution rate was measured over a set range of operating temperatures, i.e. between room temperature and 100° C. and over a set of current densities, ranging from 0 to 300 mA/cm².

The samples were run under identical conditions including electrolyte temperature, applied current, and test duration. Results are generated based on hydrogen generation, by accumulating the overall amount of hydrogen measured by the mass flow meter. Without being bound by a particular mechanism or theory, it is believed that the overall amount of hydrogen generated by the system corresponds to the corrosion reaction (undesired reaction). Thus, the less hydrogen produced, the more corrosion resistant the alloy is that is being evaluated.

Referring to the low iron samples containing <0.006 wt. % Fe (<60 ppm), it was observed that the total hydrogen generated with the fast solidification rate was ˜580 L/kg, performing better than the slow solidification rate which generated ˜700 L/kg. As a result, the difference between the fast and slow solidification rates was ˜120 L/kg.

Referring to the medium iron samples containing 0.010 wt. % (100 ppm), there is a significant difference between the fast solidification rate and the slow solidification rate in hydrogen generation. The fast solidification rate sample generated approximately 700 L/kg and the slow solidification rate generated approximately 1700 L/kg. Thus, the fast solidification rate sample containing 0.010 wt. % Fe (100 ppm) results in an aluminum electrode alloy that performs similarly to the low iron aluminum electrode alloy with slow solidification rates as typically found in DC casting.

Referring to the high iron samples containing 0.019 wt. % Fe (190 ppm), there is another significant difference between the fast solidification rate sample and the slow solidification rate sample in hydrogen generation. The fast solidification rate sample generated approximately 780 L/kg and the slow solidification rate sample generated approximately 2170 L/kg. Thus, the fast solidification rate sample containing 0.019 wt. % Fe (190 ppm) results in an aluminum electrode alloy that performs comparably to the low iron aluminum electrode alloy at slow solidification rates: 780 L/kg for samples containing 0.019 wt. % Fe (190 ppm) with fast solidification rate vs. 700 L/kg for samples containing <0.006 wt. % Fe (<60 ppm), with slow solidification rate.

Thus, without being bound by a particular mechanism or theory, it is believed that aluminum electrode alloy compositions having a higher content of iron can be utilized and will perform similarly and/or comparably to low iron content aluminum electrode alloys, provided that the high iron aluminum electrode alloys are processed/deposited with a process such that the solidification rate of the product is at least 50K/sec. Regarding the trends depicted in FIG. 3, it is believed that iron contents of up to around 0.06 wt. % Fe can be utilized with high solidification rates. The high solidification rates may maintain a high amount of iron in solid solution, meaning the iron is not within the grain structure, thereby reducing corrosion, (e.g. as quantified via hydrogen generation in an electrochemical cell).

Also referring to FIG. 3, for each of the 6 samples (at 3 different compositions), the vol. % of iron particles were detected via SEM analysis. For the low iron samples containing <0.006 wt. % Fe (<60 ppm) at either solidification rate, less than 0.001 vol. % of iron was visually observable in a representative SEM of the sample. For the medium iron samples containing 0.010 wt. % Fe (100 ppm): the fast solidification rate provided an anode containing approximately 0.01 vol. % of iron particles and the slow solidification rate provided approximately 0.02 vol. % of iron particles. For the high iron samples containing 0.019 wt. % Fe (190 ppm): the fast solidification rate provided approximately 0.02 vol. % of iron particles and the slow solidification rate provided approximately 0.04 vol. % of iron particles.

Thus, with these examples, it is observed that in one or more of the aluminum electrode alloys (e.g. anode alloys) prepared within the threshold solidification rate described allows for a comparable corrosion resistance as compared to a low iron content aluminum electrode alloy composition, when evaluated as an electrode in an electrochemical cell test.

In some embodiments, one or more of the aluminum electrode alloys (e.g. anodes) described allows for an improved corrosion resistance as compared to the same aluminum electrode alloy composition without processing within the solidification rate threshold, when evaluated as an electrode in an electrochemical cell test.

However, without wishing to be bound by theory, it is believed that, due at least in part to the processing of the aluminum electrode alloy in accordance with a threshold solidification rate, at least some of the iron may be dissolved into solid solution. This, in turn, is believed to improve the corrosion resistance (e.g. generate a lower amount of hydrogen when evaluated in an electrochemical cell test as set out in Example 2).

### Example 3: Method for Determining Particles in the Microstructure

As one non-limiting example for quantifying the solidification rate, the following procedure can be used.

The alloy sample is prepared for SEM imaging wherein: Longitudinal (L-ST) samples of the alloy are ground (e.g. for about 30 seconds) using progressively finer grit paper starting at 240 grit and moving through 320, 400, and finally to 600 grit paper. After grinding, the samples are polished (e.g., for about 2-3 minutes) on cloths using a sequence of (a) 3 μm Mol cloth and 3 μm diamond suspension, (b) 3 μm silk cloth and 3 μm diamond suspension, and finally (c) a 1 μm silk cloth and 1 μm diamond suspension. During polishing, an appropriate oil-based lubricant may be used. A final polish prior to SEM examination is to be made using 0.05 μm colloidal silica (e.g., for about 30 seconds), with a final rinse under water.

The SEM image is collected from the prepared sample, by obtaining 80 backscattered electron images at the center (T/2) and quarter thickness (T/4) of the metallographically prepared (per section 1, above) longitudinal (L-ST) sections using an FEI XL30 field emission gun scanning electron microscope (FEG-SEM), or comparable FEG-SEM. Using an image size of 2048 pixels by 1600 pixels at a magnification of 500×, the pixel dimensions are x=0.059 μm, y=0.059 μm. The accelerating voltage is to be 5.0 kV at a working distance of 5.0 mm and SEM spot size of 5. The contrast and brightness are to be set such that the average matrix grey level of the 8-bit digital image is approximately 128 and the darkest and brightest phases are 0 (black) and 255 (white) respectively.

Next, the images are assessed and the second phase particles, i.e. the iron particles in this case are identified. The average matrix grey level and standard deviation are calculated for each image. The average atomic number of the second phase particles of interest is higher than the matrix (the aluminum matrix), so the second phase particles will appear bright in the image representations. The pixels that make up the particles are defined as any pixel that has a grey level more than (>) the average matrix grey level plus 3.5 standard deviations. This critical grey level is defined as the threshold. A binary image is created by discriminating the grey level image to make all pixels higher than the threshold to be white (255) and all pixels at or higher than the threshold to be black (0).

Finally, the small particles that are not secondary phases in the grain structure are removed/filtered from the image. More specifically, any bright particle that has 4 or fewer pixels is removed from the binary image by changing its color to the background color (white). The particle density is then calculated.

While a number of embodiments of the present invention have been described, it is understood that these embodiments are illustrative only, and not restrictive, and that many modifications may become apparent to those of ordinary skill in the art. Further still, the various steps may be carried out in any desired order (and any desired steps may be added and/or any desired steps may be eliminated).

What is claimed is:

1. A method comprising:
(a) casting an aluminum alloy into an as-cast product, wherein the aluminum alloy comprises from 0.005 wt. % to 0.06 wt. % Fe; and
(b) forming the as-cast product into an aluminum electrode alloy;
wherein the casting comprises solidifying at a solidification rate;
wherein the solidification rate is at or above a threshold solidification rate;
wherein the threshold solidification rate is sufficient to achieve not greater than 0.04 vol. % of iron particles in the as-cast product.

2. The method of claim 1, wherein the threshold solidification rate is sufficient to achieve not greater than 0.03 vol. % of iron particles in the as-cast product.

3. The method of claim 1, wherein the aluminum alloy includes at least 0.02 wt. % Fe.

4. The method of claim 1, wherein the casting comprises continuous casting the aluminum alloy into a strip.

5. The method of claim 4, wherein the continuous casting comprises belt casting or roll casting.

6. The method of claim 1, wherein the casting comprises semi-continuous casting.

7. The method of claim 1, wherein the casting comprises additive manufacturing.

8. The method of claim 1, wherein the forming comprises working of the as-cast aluminum alloy.

9. The method of claim 8, wherein the working comprises rolling, forging, or extruding.

10. The method of claim 8, wherein the aluminum electrode alloy comprises a wrought structure.

11. The method of claim 1, wherein the threshold solidification rate is at least 10 K/s.

12. The method of claim 1, wherein the threshold solidification rate is at least 50K/s.

13. The method of claim 1, wherein the aluminum alloy comprises not greater than 5.0 wt. % Mg.

14. The method of claim 1, wherein the aluminum alloy comprises not greater than 4.0 wt. % Mg.

15. The method of claim 1, wherein the aluminum alloy comprises not greater than 3.0 wt. % Mg.

16. The method of claim 1, wherein the aluminum alloy comprises at least 0.5 wt. % Mg.
